(19) United States
(12) Patent Application Publication
(10) Pub. No.: US 2026/0268028 A1
(43) Pub. Date: Sep. 10, 2026

(54) METHOD AND SYSTEM FOR COUNTERACTING SIDE CHANNEL ATTACKS

(71) Applicant: National University of Singapore, Singapore (SG)

(72) Inventors: Qiang Fang, Singapore (SG); Longyang Lin, Singapore (SG); Massimo Alioto

(21) Appl. No.: 19/491,362

(22) PCT Filed: Jun. 7, 2024
(86) PCT No.: PCT/SG2024/050376

§ 371 Date: Dec. 8, 2025

(30) Foreign Application Priority Data
Jun. 9, 2023 (SG) 10202301641R

(51) Int. Cl. G06F 21/75; G06F 7/544; G06F 7/58; G06N 20/00

(52) U.S. Cl. CPC G06F 21/755; G06F 7/5443; G06F 7/58; G06N 20/00

(57) ABSTRACT

A method for counteracting side channel attacks in a system comprising a neural network including processing element tiles is described in an embodiment. The method comprising: spatially shuffling, using a first random sequence generator, an assignment mapping of an output of the neural network to the processing element tiles, where the output of the neural network includes a series of Multiply-Accumulate (MAC) operations, and shuffling, using a second random sequence generator, multiplies of the series of MAC operations in a run sequence temporally. A system for counteracting side channel attacks is also described in an embodiment.

### TECHNICAL FIELD

The present disclosure relates to a method and system for counteracting side channel attacks.

### BACKGROUND

Neural networks (NN) are ubiquitously present in today's silicon and embedded systems, and their security is crucial due to high values of their confidential parameters or weights. They are therefore potential sources of vulnerabilities to hackers or attackers. To circumvent conventional encrypted volatile storages, side channel attacks such as correlation power analysis (CPA) attacks and electromagnetic attacks are effective in extracting these parameters or weights from neural networks. These side channel attacks are also capable of targeting either a weight decryption or the neural network array directly.

To counter against side channel neural network reverse engineering or attacks, counteraction techniques including threshold implementation (TI) countermeasures, masking-based counteractions, multiply-accumulate (MAC)-level temporal shuffling counteraction and machine-learning power compensation have been proposed.

However, each of these counteraction techniques have their disadvantages. For example, although the threshold implementation (TI) countermeasure offers one of the highest levels of protection of up to millions of power traces, it has a large power overhead (5.48×). Similarly, masking-based counteraction techniques typically require a large latency, area, and power overhead, and substantial design efforts for masking all individual functions being executed. On the other hand, although MAC-level shuffling counteraction technique may have a lower area and power overhead as compared to the aforementioned counteraction method, its protection is less effective as it typically offers less than a million MTD and is degradable at small kernels (e.g., 3×3 which is commonly used in convolutional NNs). Further, machine learning power compensation is only applicable to encryption and its protection degrade under voltage scaling.

It is therefore desirable to provide a method and system for counteracting side channel attacks which address the aforementioned problems and/or provide a useful alternative. Further, other desirable features and characteristics will become apparent from the subsequent detailed description and the appended claims, taken in conjunction with the accompanying drawings and this background of the disclosure.

### SUMMARY

Aspects of the present application relate to a method and system for counteracting side channel attacks.

In accordance with a first aspect, there is provided a method for counteracting side channel attacks in a system comprising a neural network including processing element tiles, the method comprising: spatially shuffling, using a first random sequence generator, an assignment mapping of an output of the neural network to the processing element tiles, wherein the output of the neural network includes a series of Multiply-Accumulate (MAC) operations; and shuffling, using a second random sequence generator, multiplies of the series of MAC operations in a run sequence temporally.

By using a first random sequence generator to spatially shuffle an assignment mapping of an output of the neural network to the processing element tiles, processing element tiles are randomised to degrade a signal-to-noise (SNR) ratio of an electromagnetic attack, thereby reducing a need for additional routing such as metal shielding or extra metal routing. Further, in the present embodiment where the output of the neural network includes a series of Multiply-Accumulate (MAC) operations, the spatially shuffling of the assignment mapping is used in combination with temporal shuffling of multiplies of the series of MAC operations in a run sequence to provide improve protection against both correlation power analysis attacks and EM attacks.

The system may comprise a machine learning (ML) power compensation unit, dynamic power digital-to-analogue converters (DACs) and static power digital-to-analogue converters (DACs), and the method may comprise: receiving, from the processing element tiles, inputs in relation to dynamic power parameters and static power parameters; training a dynamic power compensation ML model associated with the ML power compensation unit, using the dynamic power parameters, to form a trained dynamic power compensation ML model; training a static power compensation ML model associated with the ML power compensation unit, using the static power parameters, to form a trained static power compensation ML model; controlling, using the trained dynamic power compensation ML model, dynamic power compensation using the dynamic power DACs; and controlling, using the trained static power compensation ML model, static power compensation using the static power DACs.

The method may comprise: receiving dynamic power inputs and static power inputs associated with the neural network and/or an encryption circuit of the system; training the trained dynamic power compensation ML model, using the dynamic power inputs, to form a further trained dynamic power compensation ML model; training the trained static power compensation ML model, using the static power inputs, to form a further trained static power compensation ML model; controlling, using the further trained dynamic power compensation ML model, dynamic power compensation associated with the neural network and/or the encryption circuit of the system; and controlling, using the further trained static power compensation ML model, static power compensation associated with the neural networks and/or the encryption circuit of the system.

Where the dynamic power parameters may include dynamic power traces and the static power parameters may include static power traces, training the dynamic power compensation ML model using the dynamic power parameters and training the static power compensation ML model using the static power parameters may comprise: (i) initialising dynamic machine learning parameters for the dynamic power compensation ML model and static machine learning parameters for the static power compensation ML model; (ii) setting the system to dynamic power dominate condition and receiving the dynamic power traces associated with the initialised dynamic machine learning parameters from the processing element tiles; (iii) determining if there is a side channel leakage as a result of a side channel attack to the system; (iv) if it is determined that there is no side channel leakage, ending the training of the dynamic power compensation ML model and the static power compensation ML model; or (v) if it is determined that there is a side channel leakage, extracting dynamic power leakage parameters using the dynamic power compensation ML model and training the dynamic power compensation ML model based on the extracted dynamic power leakage parameters; (vi) setting the system to static power dominate condition and receiving the static power traces associated with the initialised static machine learning parameters; (vii) determining if there is a further side channel leakage as a result of a further side channel attack to the system; (viii) if it is determined that there is no further side channel leakage, ending the training of the dynamic power compensation ML model and the static power compensation ML model; or (ix) if it is determined that there is a further side channel leakage, extracting static power leakage parameters using the static power compensation ML model and training the static power compensation ML model based on the static power leakage parameters, wherein the steps (ii) to (ix) above are repeated until a predetermined minimum trace to disclosure (MTD) is achieved.

In accordance with a second aspect, there is provided a method for counteracting side channel attack in a system comprising a neural network including processing element tiles, a machine learning (ML) power compensation unit, dynamic power digital-to-analogue converters (DACs) and static power digital-to-analogue converters (DACs), the method comprising: receiving, from the processing element tiles, inputs in relation to dynamic power parameters and static power parameters; training, a dynamic power compensation ML model associated with the ML power compensation unit, using the dynamic power parameters to form a trained dynamic power compensation ML model; training, a static power compensation ML model associated with the ML power compensation unit, using the static power parameters to form a trained static power compensation ML model; controlling, using the trained dynamic power compensation ML model, dynamic power compensation associated using the dynamic power DACs; and controlling, using the trained static power compensation ML model, static power compensation associated using the static power DACs, wherein the steps of training the dynamic power compensation ML model and training the static power compensation ML model are performed iteratively.

By using the trained dynamic power compensation ML model and the trained static power compensation ML model individually to control the dynamic power compensation associated with the dynamic power DACs and the static power compensation associated with the static power DACs respectively in a decoupled manner, the present method for counteracting side channel attacks is effective with input voltage scaling regardless of a supply voltage (V_{DD}) to a system under protection (e.g. neural network, processing elements etc.). Particularly, the trained dynamic power compensation ML model and the trained static power compensation ML model of the present method, having decoupled, are therefore adapted to track a dynamic power to static power ratios of the system so that the present counteraction method is “voltage scaling agnostic”—which means that the present counteraction method offers strong, accurate and robust protection irrespective of different dynamic power to static power ratios of the system due to a change in voltage scaling of the system. Further, the dynamic power compensation ML model and the static power compensation ML model are trained alternatively and iteratively and these allow incorporating of all dynamic and static power contributions from the system. In an embodiment, incorporating all dynamic and static power contributions from the system include dynamic and static power contributions from the dynamic and static power DACs, neural network (NN) and an encryption circuit (AES) for a system-level voltage scaling-agnostic machine learning (VML) power compensation.

The dynamic power parameters may include dynamic power traces and the static power parameters may include static power traces, training the dynamic power compensation ML model using the dynamic power parameters and training the static power compensation ML model using the static power parameters may comprise: (i) initialising dynamic machine learning parameters for the dynamic power compensation ML model and static machine learning parameters for the static power compensation ML model; (ii) setting the system to dynamic power dominate condition and receiving the dynamic power traces associated with the initialised dynamic machine learning parameters from the processing element tiles; (iii) determining if there is a side channel leakage as a result of a side channel attack to the system; (iv) if it is determined that there is no side channel leakage, ending the training of the dynamic power compensation ML model and the static power compensation ML model; or (v) if it is determined that there is a side channel leakage, extracting dynamic power leakage parameters using the dynamic power compensation ML model and training the dynamic power compensation ML model based on the extracted dynamic power leakage parameters; (vi) setting the system to static power dominate condition and receiving the static power traces associated with the initialised static machine learning parameters from the processing element tiles; (vii) determining if there is a further side channel leakage as a result of a further side channel attack to the system; (viii) if it is determined that there is no further side channel leakage, ending the training of the dynamic power compensation ML model and the static power compensation ML model; or (ix) if it is determined that there is a further side channel leakage, extracting static power leakage parameters using the static power compensation ML model and training the static power compensation ML model based on the static power leakage parameters, wherein the steps (ii) to (ix) above are repeated until a predetermined minimum trace to disclosure (MTD) is achieved.

In accordance with a third aspect, there is provided a system for counteracting side channel attacks, the system comprising: a neural network including processing element tiles, the neural network being adapted to generate an output as a series of Multiply-Accumulate (MAC) operations; a first random sequence generator adapted to be used in spatially shuffling an assignment mapping of the output of the neural network to the processing element tiles; and a second random sequence generator configured to be used in shuffling multiplies of the series of MAC operations in a run sequence temporally. A same random sequence generator may be adapted to be used as the first random sequence generator and the second random sequence generator.

The first random sequence generator or the second random sequence generator may include a Fisher-Yates random sequence generator.

The system may comprise: a machine learning (ML) power compensation unit adapted to track a dynamic power-to-static power ratio of the system, the ML power compensation unit comprising a dynamic power compensation ML model and a static power compensation ML model; dynamic power digital-to-analogue converters (DACs); and static power digital-to-analogue converters (DACs), wherein inputs in relation to dynamic power parameters and static power parameters received from the processing element tiles are used to train the dynamic power compensation ML model to form a trained dynamic power compensation ML model and to train a static power compensation ML model to form a trained static power compensation ML model, respectively, and wherein the ML power compensation unit is further adapted to control dynamic power compensation associated with the dynamic power DACs using the trained dynamic power compensation ML model and to control static power compensation associated with the static power DACs using the trained static power compensation ML model.

Where dynamic power inputs and static power inputs associated with the neural network and/or an encryption circuit of the system may be used to train the trained dynamic power compensation ML model and the trained static power compensation ML model respectively to form a further trained dynamic power compensation ML model and a further trained static power compensation ML model, the ML power compensation unit may be further adapted to: control, using the further trained dynamic power compensation ML model, dynamic power compensation associated with the neural network and/or the encryption circuit of the system; and control, using the further trained static power compensation ML model, static power compensation associated with the neural networks and/or the encryption circuit of the system.

The encryption circuit may include an Advanced Encryption Standard circuit, the encryption circuit may be adapted to protect a dynamic power-to-static power ratio used in the neural network from unauthorized disclosure.

Where the dynamic power parameters may include dynamic power traces and the static power parameters may include static power traces, the ML power compensation unit may be adapted to: (i) initialise dynamic machine learning parameters for the dynamic power compensation ML model and static machine learning parameters for the static power compensation ML model; (ii) set the system to dynamic power dominate condition and receive the dynamic power traces associated with the initialised dynamic machine learning parameters from the processing element tiles; (iii) determine if there is a side channel leakage as a result of a side channel attack to the system; (iv) if it is determined that there is no side channel leakage, end the training of the dynamic power compensation ML model and the static power compensation ML model; or (v) if it is determined that there is a side channel leakage, extract dynamic power leakage parameters using the dynamic power compensation ML model and train the dynamic power compensation ML model based on the extracted dynamic power leakage parameters; (vi) set the system to static power dominate condition and receive the static power traces associated with the initialised static machine learning parameters from the processing element tiles; (vii) determine if there is a further side channel leakage as a result of a further side channel attack to the system; (viii) if it is determined that there is no further side channel leakage, end the training of the dynamic power compensation ML model and the static power compensation ML model; or (ix) if it is determined that there is a further side channel leakage, extract static power leakage parameters using the static power compensation ML model and train the static power compensation ML model based on the static power leakage parameters, wherein the ML power compensation unit is further adapted to repeat the steps (ii) to (ix) above until a predetermined minimum trace to disclosure (MTD) is achieved.

The dynamic power DACs may include a 10-bit inverter-based dynamic power DACs and the static power DACs may include NAND-based or NOR-based static power DACs

In accordance with a fourth aspect, there is provided a system for counteracting side channel attack, the system comprising: a neural network including processing element tiles; a machine learning (ML) power compensation unit, the ML power compensation unit comprising a dynamic power compensation ML model and a static power compensation ML model; dynamic power digital-to-analogue converters (DACs); and static power digital-to-analogue converters (DACs), wherein inputs in relation to dynamic power parameters and static power parameters received from the processing element tiles are used to train the dynamic power compensation ML model to form a trained dynamic power compensation ML model and to train a static power compensation ML model to form a trained static power compensation ML model, respectively, and wherein the ML power compensation unit is adapted to control dynamic power compensation associated with the dynamic power DACs using the trained dynamic power compensation ML model and to control static power compensation associated with the static power DACs using the trained static power compensation ML model.

The dynamic power parameters may include dynamic power traces and the static power parameters may include static power traces, the ML power compensation unit may be adapted to: (i) initialise dynamic machine learning parameters for the dynamic power compensation ML model and static machine learning parameters for the static power compensation ML model; (ii) set the system to dynamic power dominate condition and receive the dynamic power traces associated with the initialised dynamic machine learning parameters from the processing element tiles; (iii) determine if there is a side channel leakage as a result of a side channel attack to the system; (iv) if it is determined that there is no side channel leakage, end the training of the dynamic power compensation ML model and the static power compensation ML model; or (v) if it is determined that there is a side channel leakage, extract dynamic power leakage parameters using the dynamic power compensation ML model and train the dynamic power compensation ML model based on the extracted dynamic power leakage parameters; (vi) set the system to static power dominate condition and receive the static power traces associated with the initialised static machine learning parameters from the processing element tiles; (vii) determine if there is a further side channel leakage as a result of a further side channel attack to the system; (viii) if it is determined that there is no further side channel leakage, end the training of the dynamic power compensation ML model and the static power compensation ML model; or (ix) if it is determined that there is a further side channel leakage, extract static power leakage parameters using the static power compensation ML model and train the static power compensation ML model based on the static power leakage parameters, wherein the ML power compensation unit is further adapted to repeat the steps (ii) to (ix) above until a predetermined minimum trace to disclosure (MTD) is achieved.

It should be appreciated that features relating to one aspect may be applicable to the other aspects. Embodiments provide a method and system for counteracting side channel attacks. Particularly, by using a first random sequence generator to spatially shuffle an assignment mapping of an output of the neural network to the processing element tiles, processing element tiles are randomised to degrade a signal-to-noise (SNR) ratio of an electromagnetic attack, thereby reducing a need for additional routing such as metal shielding or extra metal routing. In the present embodiment, where the output of the neural network includes a series of Multiply-Accumulate (MAC) operations, the spatially shuffling of the assignment mapping is used in combination with temporal shuffling of multiplies of the series of MAC operations in a run sequence to provide improvements in protection against both correlation power analysis attacks and EM attacks. In an embodiment, a Fisher-Yates random sequence generator is adopted as the first random sequence generator to provide the spatial shuffling and/or the temporal shuffling, providing no repetition in a mapping of the output of the neural network, thereby achieving zero latency degradation. Alternatively, or additionally, a ML power compensation unit comprising a dynamic power compensation ML model and a static power compensation ML model can be used for VML power compensation. By using the trained dynamic power compensation ML model and the trained static power compensation ML model individually to control the dynamic power compensation associated with the dynamic power DACs and the static power compensation associated with the static power DACs respectively in a decoupled manner, the present method for counteracting side channel attacks is effective with input voltage scaling regardless of a supply voltage (V_{DD}) to a system under protection (e.g. neural network, processing elements, encryption circuit etc.). Particularly, the trained dynamic power compensation ML model and the trained static power compensation ML model of the present method, having decoupled, are therefore adapted to track a dynamic power to static power ratios of the system so that the present counteraction method is “voltage scaling agnostic”-which means that the present counteraction method offers strong, accurate and robust protection irrespective of different dynamic power to static power ratios of the system due to a change in voltage scaling of the system. Further, the dynamic power compensation ML model and the static power compensation ML model are trained alternatively and iteratively and these allow incorporating all dynamic and static power contributions from the system. In an embodiment, incorporating all dynamic and static power contributions from the system include dynamic and static power contributions from the dynamic and static power DACs, neural network (NN) (e.g. weights and/or parameters of the NN), processing elements, and an encryption circuit (AES) for a system-level voltage scaling-agnostic machine learning (VML) power compensation.

### BRIEF DESCRIPTION OF THE DRAWINGS

Embodiments will now be described, by way of example only, with reference to the following drawings, in which:

FIG. 1 is a schematic diagram illustrating multiple side channel vulnerabilities of an on-chip neural network;

FIG. 2 is a diagram illustrating machine-learning based counteraction of a prior art against side channel attacks;

FIG. 3 is a graph illustrating dynamic energy and static energy contributions of a system as a function of a supply voltage to the system in accordance with an embodiment;

FIGS. 4A and 4B are schematic diagrams illustrating temporal shuffling of Multiply-Accumulate (MAC) operations as a form of counteraction of a prior art against side channel attacks, where FIG. 4A is a schematic diagram illustrating a concept of temporal shuffling of MAC multiplies and FIG. 4B is a schematic diagram illustrating an inefficiency of the temporal shuffling of MAC operations counteraction method;

FIG. 5 shows a schematic diagram of a system for counteracting side channel attacks in accordance with an embodiment;

FIG. 6 is a flowchart of a method for counteracting side channel attacks in accordance with an embodiment;

FIG. 7 shows a schematic diagram of a system architecture for counteracting side channel attacks comprising voltage scaling-agnostic machine learning counteraction and Multiply-Accumulate (MAC) level shuffling in accordance with an embodiment;

FIG. 8 shows circuit diagrams illustrating NOR2-based circuit for PMOS static power compensation and NAND2-based circuit for NMOS static power compensation in accordance with an embodiment;

FIG. 9 shows a flowchart of a method for training a dynamic power compensation ML model and a static power compensation ML model in accordance with an embodiment;

FIG. 10 shows a graph of measured minimum traces to disclosure (MTD) versus a number of retraining iterations for training the dynamic power compensation ML model and the static power compensation ML model using the method of FIG. 9 in accordance with an embodiment;

FIG. 11 shows a schematic diagram illustrating spatial shuffling of an assignment mapping of an output of the neural network to processing element tiles for counteracting side channel attacks in accordance with an embodiment;

FIG. 12A and FIG. 12B are diagrams illustrating a Fisher-Yates-based random sequence generator (RSG) for use in MAC level shuffling for counteracting side channel attacks in accordance with an embodiment, where FIG. 12A is a diagram illustrating an efficiency of spatial shuffling where all outputs are mapped with N-splits with zero latency overhead and FIG. 12B is a diagram illustrating an architecture of the Fisher-Yates-based random sequence generator (RSG);

FIG. 13 shows a micrograph of a test chip for use in simulated side channel attacks in accordance with an embodiment;

FIG. 14 shows a photograph of an experimental setup for simulating side channel attacks on the test chip of FIG. 13 in accordance with an embodiment;

FIG. 15 shows a graph of MTDs for unprotected and protected neural networks under correlation power attacks (CPA) and electromagnetic attacks in accordance with an embodiment;

FIG. 16 shows a graph of test vector leakage assessment (TVLA) test for unprotected and protected neural networks in accordance with an embodiment;

FIG. 17 shows charts illustrating frequency scaling and its impact on MTDs for unprotected and protected neural networks, and dynamic power-to-static power ratio of the neural network, in accordance with an embodiment; and

FIG. 18 shows charts illustrating supply voltage scaling and its impact on MTDs for unprotected and protected neural networks, and dynamic power-to-static power ratio of the neural network, in accordance with an embodiment.

### DETAILED DESCRIPTION

Exemplary embodiments relate to a method and system for counteracting side channel attacks.

In the exemplary embodiments as described below, counteraction methods and systems against side channel attacks are presented. These include a multi-level shuffling counteraction method comprising spatial and temporal randomisation, and a voltage scaling-agnostic machine learning (VML) compensation counteraction method which provides robust protection under voltage scaling. The use of these counteraction methods provide protection for the neural network array and against neural network weight reverse engineering.

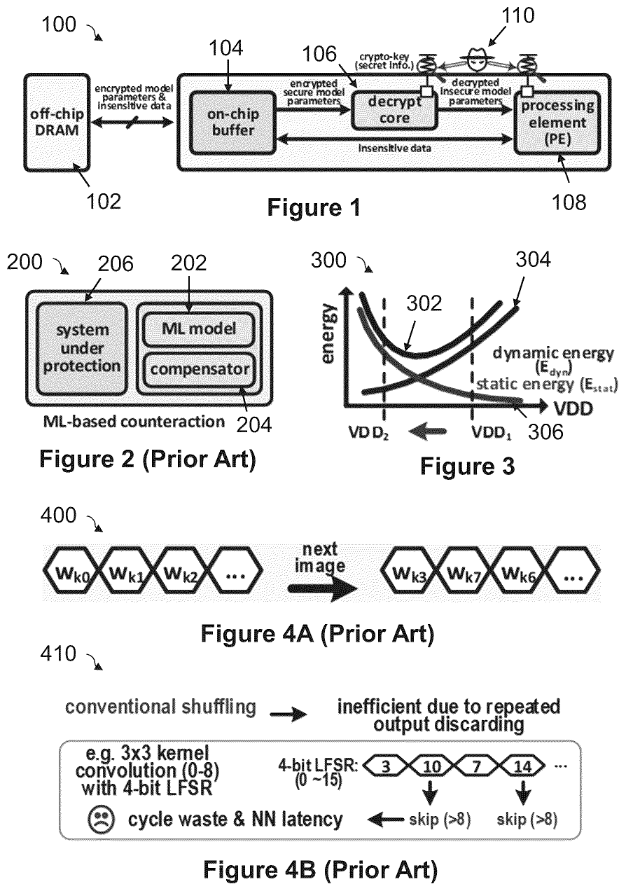

FIG. 1 is a schematic diagram 100 illustrating multiple side channel vulnerabilities of an on-chip neural network in a system.

An shown in FIG. 1, encrypted neural network model parameters and other data (e.g. insensitive data) can be transmitted from an off-chip dynamic random access memory (DRAM) 102 to a system on chip comprising an on-chip buffer 104, a decrypt core 106 and processing elements (PE) 108. The on-chip buffer 104 is configured as a temporary storage for receiving the encrypted model parameters and other data from the off-chip DRAM 102. The decrypt core 106 is adapted to decrypt the encrypted model parameters received from the on-chip buffer 104. The processing elements (PE) 108 may include a PE array structure configured to perform MAC operations for the neural network.

In side channel attacks as illustrated in FIG. 1, to circumvent conventional encrypted volatile storage (e.g. the off-chip DRAM 102 and/or on-chip buffer 104), correlation power analysis (CPA) and electromagnetic (EM) side channel attacks 110 can be used to target either the decrypted model parameters/weights or the PE array of the neural network.

Therefore, multiple side channel attack protections for both the decrypt core 106 and the PEs 108 of the neural network are desired.

FIG. 2 show a diagram 200 to illustrate machine-learning (ML) based counteraction against side channel attacks in relation to a prior art. As shown in the diagram 200, a machine learning model 202 is coupled with a power compensator 204 to provide power compensation to protect a system 206 against side channel attacks. In this counteraction method, dynamic power compensation is considered. However, this counteraction method is ineffective and provides inaccurate compensation for voltage scaling.

The issue in relation to voltage scaling of the counteraction method of FIG. 2 is illustrated using FIG. 3.

FIG. 3 is a graph 300 illustrating dynamic energy and static energy contributions of a system as a function of a supply voltage to the system in accordance with an embodiment. As shown in the graph 300, a total energy Eₜₒₜ 302 of the system includes both dynamic energy component E_{dyn} 304 and static energy component Eₛₜₐₜ 306, which can be written in the form of Eₜₒₜ=E_{dyn}+Eₛₜₐₜ=E_{dyn} (1+Eₛₜₐₜ/E_{dyn}). When a supply voltage to the system (e.g. including the decrypt core 106 and/or the neural network processing elements 108) is scaled (or is changed), a ratio of the dynamic energy (or dynamic power) to the static energy (or static power) is changed as shown in the graph 300. A machine-learning (ML)-based counteraction built on dynamic power compensation is therefore ineffective against voltage scaling of the supply voltage to the system as the voltage scaling alters the dynamic power to static power ratio and thereby rendering the trained ML model-based counteraction ineffective. For example, a power compensator of the counteraction method of FIG. 2 can be trained at VDD₁ as shown in the graph 300 of FIG. 3 but will offer inaccurate compensation if the VDD₁ is scaled to VDD₂ because the Eₛₜₐₜ/E_{dyn} ratio is different at VDD₂ as compared to VDD₁ as shown. In other words, the power compensator of the counteraction method of FIG. 2 cannot track both Eₛₜₐₜ and E_{dyn} across different VDDs, leading to MTD degradation with a scaling of the supply voltage (V_{DD}) of the system.

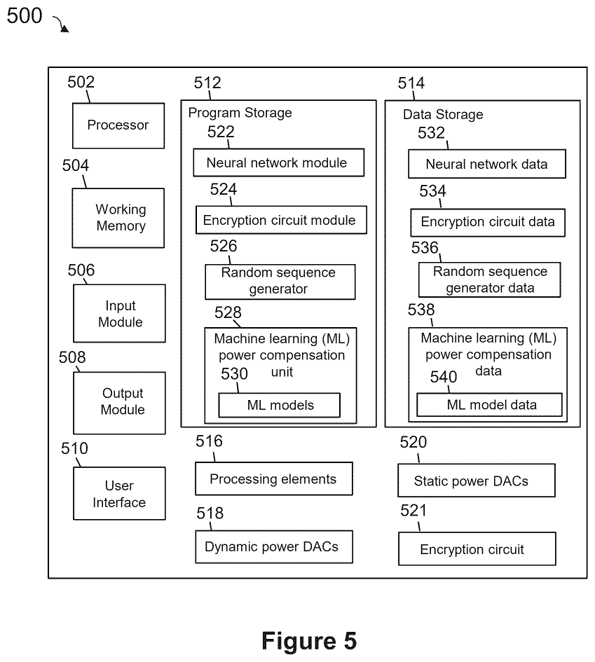

FIGS. 4A and 4B are schematic diagrams 400, 410 illustrating temporal shuffling of Multiply-Accumulate (MAC) operations as a form of counteraction of a prior art against side channel attacks.

FIG. 4A is a schematic diagram 400 illustrating a concept of temporal shuffling of MAC multiplies. To illustrate this, an output of a fully-connected layer or a convolution layer of a neural network can be in the form of a series of MAC operations as shown in the equation below:

$${y}_{k} = {\sum }_{i = 0}^{n - 1} {w}_{k , i} * {x}_{i} + {b}_{k}$$

In relation to a fully-connected layer, k is the k^{th} layer output and n is an input neuron size in the above equation. In relation to a convolution layer, k is the k^{th} layer output and n is a kernel size in the above equation.

As shown in FIG. 4A, a run sequence of the model parameters or weight W_{k,i} of the MAC operations can be shuffled temporally as a form of counteraction against side channel attacks. For example, temporal shuffling the MAC operations includes shuffling the processed data over a period of time or in several clock cycles so that an attacker would not be able to determine the processed data for a specific cycle. For example, if an original data is A, B, C for 3 clock cycles, after temporal shuffling, the processed data may be randomised as B, A, C for the 3 clock cycles. This helps to decrease the SNR of an attack as the attacker needs to know the relationship between power of a certain clock cycle and its processed data.

FIG. 4B is a schematic diagram 410 illustrating an inefficiency of the temporal shuffling of MAC operations counteraction method as shown in relation to FIG. 4A. In this example, the neural network includes a 3×3 kernel convolution which has kernel indices from 0 to 8 (i.e. 9 values). It should be appreciated that kernel indices can run from 1 to k², where k=kernel size. In the present example, a minimal 4-bit linear-feedback shift register (LFSR) is to be used as, for example, a 3-bit LFSR will only provide 8 values which is insufficient in this case. In the present case, any cycles associated with the 4-bit LFSR that generate a value larger than 8 would be skipped. Therefore, as shown in FIG. 4B, the 4-bit LFSR based run-time coverage of the indexes of multiplies of a MAC operation leads to several indexes being discarded (in this case, indices 10 and 14 which have values larger than 8 and are out of bound). This results in cycle wastage due to discarding of repeated output, thereby increasing a latency of the PE arrays for performing the MAC operations.

FIG. 5 shows a block diagram of a system 500 for counteracting side channel attacks in accordance with an embodiment.

The system 500 has memory that stores computer program modules which implement the methods for counteracting side channel attacks as described in the present disclosure. The system 500 comprises a processor 502, a working memory 504, an input module 506, an output module 508, a user interface 510, a program storage 512 and a data storage 514. In the present embodiment, the system 500 includes processing elements 516, dynamic power digital-to-analog converters (DACs) 518, static power DACs 520 and an encryption circuit 521.

The processor 502 may be implemented as one or more central processing unit (CPU) chips. The program storage 512 is a non-volatile storage device such as a hard disk drive which stores computer program modules such as a neural network module 522, an encryption circuit module 524, a random sequence generator 526 and a machine learning (ML) power compensation unit 528 comprising machine learning (ML) models 530. The machine learning models 530 include a dynamic power compensation ML model and a static power compensation ML model. The computer program modules are loaded into the working memory 504 for execution by the processor 502. The working memory 504 includes static random access memory (SRAM) and/or dynamic random access memory (DRAM). The input module 506 is an interface which allows data to be received by the system 500. The output module 508 is an output device which allows data and results generated by the system 500 to be output. The output module 508 may be coupled to a display device or a printer. The user interface 510 allows a user of the system 500 to input selections and commands and may be implemented as a graphical user interface. The processing elements 516 in the present embodiment includes an array of processing element tiles adapted to perform MAC operations for the neural network. This may include receiving model parameters and/or inputs of the neural network and providing outputs for the neural network, for example, for a fully-connected layer or a convolution layer of the neural network. In the present embodiment, the dynamic power DACs 518 and the static power DACs 520 are adapted to provide dynamic power compensation and static power compensation, respectively, to the system 500 for counteracting side channel attacks. The encryption circuit 521 is adapted to protect a dynamic power-to-static power ratio used in the neural network from unauthorised disclosure, and in an embodiment includes an Advanced Encryption Standard (AES) circuit. Although the components/elements 502, 504, 506, 508, 510, 516, 518, 520 and 521 are shown as distinct elements, in some embodiments, part of the working memory 504 and the processing elements 516 can be integrated with the processor 502 to form an application specific integrated circuit (ASIC) or a system on chip architecture. It should therefore be appreciated that the boundaries between these components/elements are exemplary only, and that alternative embodiments may merge or impose an alternative decomposition of functionality of these components/elements.

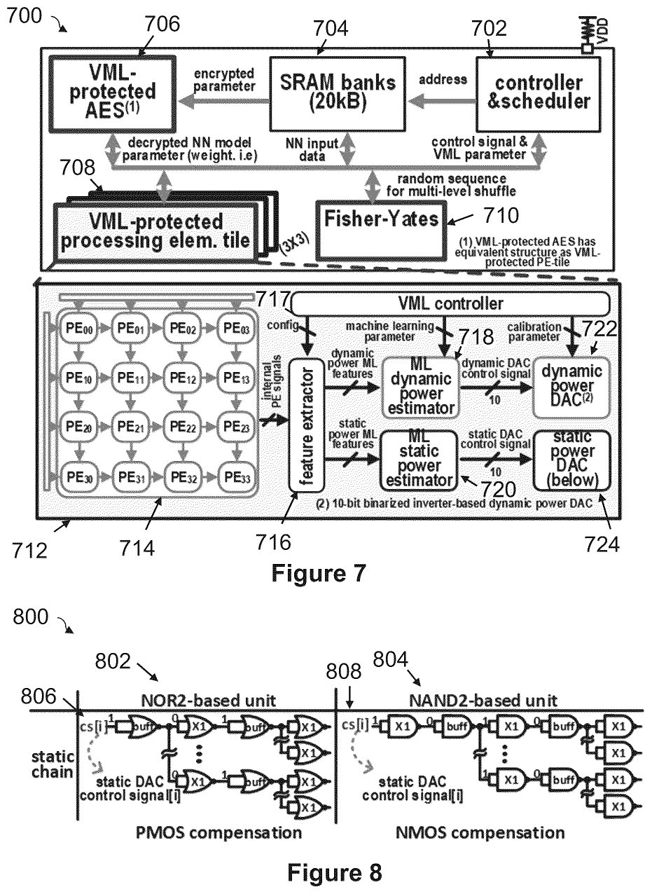

The program storage 512 stores the neural network module 522, the encryption circuit module 524, the random sequence generator 526 and the machine learning (ML) power compensation unit 528 comprising the machine learning (ML) models 530. These computer program modules cause the processor 502 to execute various analytical processes which are described in more detail below. For example, the neural network module 522 can be executed by the processor 502 to receive user inputs via the input module 506 for generating neural network outputs. In the present embodiment, the neural network and its associated parameters (e.g. model parameters and outputs etc.) are protected from side channel attacks. The encryption circuit module 524 is adapted to work with the encryption circuit 521 to protect the dynamic power-to-static power ratio used in the neural network from unauthorized disclosure. The random sequence generator 526 is adapted to be used in spatially shuffling an assignment mapping of an output of the neural network to the processing elements 516 of the system. In an embodiment, the random sequence generator 526 is also adapted to be used in shuffling multiplies of the series of MAC operations in a run sequence temporally. The random sequence generator 526 may include a Fisher-Yates random sequence generator. The machine learning (ML) power compensation unit 528 is adapted to track a dynamic power-to-static power ratio of the system 500, train the dynamic power compensation ML model and the static power compensation ML model, and control dynamic power compensation associated with the dynamic power DACs using the trained dynamic power compensation ML model and control static power compensation associated with the static power DACs using the trained static power compensation ML model. Though not shown explicitly in FIG. 5, the ML power compensation unit 528 may include a controller (e.g. a VML controller as shown in FIG. 7) for controlling the dynamic power compensation and the static power compensation. In an embodiment, the ML power compensation unit 528 is adapted to train the dynamic power compensation ML model and the static power compensation ML model using dynamic power inputs and static power inputs associated with the neural network and/or the encryption circuit 521 of the system, and to control dynamic power compensation and static power compensation associated with the neural networks and/or the encryption circuit of the system using a trained (or further trained) dynamic power compensation ML model and a trained (or further trained) static power compensation ML model, respectively.

The program storage 512 may be referred to in some contexts as computer readable storage media and/or non-transitory computer readable media. As depicted in FIG. 5, the computer program modules 522, 524, 526, 528 and 530 are distinct modules which perform respective functions implemented by the system 500. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the computer program modules is described herein, these may alternatively be implemented as one or more hardware modules (such as field-programmable gate array(s) or application-specific integrated circuit(s)) comprising circuitry which implements equivalent functionality to that implemented in software.

The data storage 514 stores various data and parameters. As shown in FIG. 5, the data storage 514 has storage for neural network data 532, encryption circuit data 534, random sequence generator data 536, and machine learning (ML) power compensation data 538 including ML model data 540 for use with their corresponding computer program modules 522, 524, 526, 528 and 530. For example, the neural network data 532 includes neural network parameters and other insensitive data for use with the neural network module 522, the encryption circuit data 534 includes data for use with the encryption circuit module 524 such as look-up tables etc. and the random sequence generator data 536 includes data associated with the random sequence generator 526 such as a mapping of an output of the random sequence generator 526 to the process element tiles or in an embodiment, look-up tables used in a Fisher-Yates random sequence generator. The machine learning (ML) power compensation data 538 includes ML model data 540 associated with the dynamic power compensation ML model and the static power compensation ML model. This may include dynamic power parameters received from the processing elements 516 and/or dynamic power inputs and static power inputs associated with the neural network and/or the encryption circuit 521 for training the dynamic power compensation ML model and the static power compensation ML model. The ML model data 540 may also include dynamic machine learning parameters associated with the dynamic power compensation ML model and static machine learning parameters associated with the static power compensation ML model.

Although the technical architecture is described with reference to a system 500, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by a computer program module may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing a computer program module or computer program modules in a cloud computing environment. Cloud computing may comprise providing computing services via a system connection using dynamically scalable computing resources. A cloud computing environment may be established by an enterprise and/or may be hired on an as-needed basis from a third-party provider.

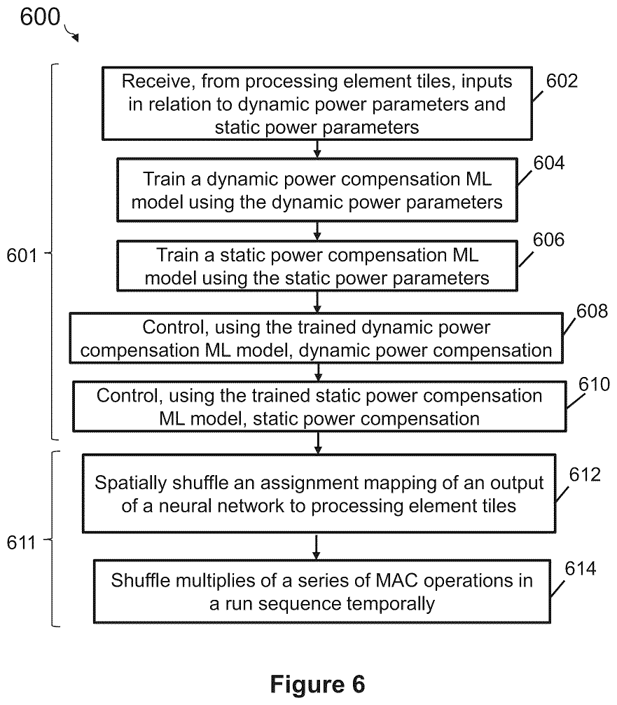

FIG. 6 is a flowchart of a method 600 for counteracting side channel attacks in accordance with an embodiment. In the present embodiment, the method 600 includes a combination of the voltage scaling-agnostic machine learning (VML) power compensation method 601 and spatial and temporal shuffling method 611 using the random sequence generator (RSG) 526. It should be appreciated that the methods 601 and 611 can also be used independent of each other in other embodiments. In other words, it is not necessary to use the methods 601 and 611 in conjunction.

In a step 602, the ML power compensation unit 528 is executed by the processor 502 to receive, from the processing element tiles, inputs in relation to dynamic power parameters and static power parameters. In an embodiment, the ML power compensation unit 528 is executed by the processor 502 to receive dynamic power inputs and static power inputs associated with the neural network and/or the encryption circuit 521 of the system 500.

In a step 604, the ML power compensation unit 528 is executed by the processor 502 to train the dynamic power compensation ML model using the dynamic power parameters to form a trained dynamic power compensation ML model. In an embodiment, where dynamic power inputs and static power inputs associated with the neural network and/or the encryption circuit 521 of the system 500 are received, the ML power compensation unit 528 is executed by the processor 502 to further train the dynamic power compensation ML model using the dynamic power inputs.

In a step 606, the ML power compensation unit 528 is executed by the processor 502 to train the static power compensation ML model using the static power parameters to form a trained static power compensation ML model. In an embodiment, where dynamic power inputs and static power inputs associated with the neural network and/or the encryption circuit 521 of the system 500 are received, the ML power compensation unit 528 is executed by the processor 502 to further train the static power compensation ML model using the static power inputs.

In a step 608, the ML power compensation unit 528 is executed by the processor 502 to control, using the trained dynamic power compensation ML model, dynamic power compensation using the dynamic power DACs. In an embodiment where the ML power compensation unit 528 is executed by the processor 502 to further train the dynamic power compensation ML model using the dynamic power inputs associated with the neural network and/or the encryption circuit 521 of the system 500, the ML power compensation unit 528 is executed by the processor 502 to control dynamic power compensation associated with the neural network and/or the encryption circuit using the further trained dynamic power compensation ML model.

In a step 610, the ML power compensation unit 528 is executed by the processor 502 to control, using the trained static power compensation ML model, static power compensation using the static power DACs. In an embodiment where the ML power compensation unit 528 is executed by the processor 502 to further train the dynamic power compensation ML model using the static power inputs associated with the neural network and/or the encryption circuit 521 of the system 500, the ML power compensation unit 528 is executed by the processor 502 to control static power compensation associated with the neural network and/or the encryption circuit using the further trained static power compensation ML model.

In a step 612, the random sequence generator 526 is executed by the processor 502 for use in spatially shuffling an assignment mapping of an output of the neural network to the processing element tiles of the system 500. The random sequence generator 526 may include a Fisher-Yates random sequence generator.

In a step 614, the random sequence generator 526 is executed by the processor 502 for use in shuffling multiplies of the series of MAC operations in a run sequence temporally.

The method 600 of the present embodiment therefore combines voltage scaling-agnostic machine learning (VML) dynamic and static power compensation counteraction with dual spatial and temporal shuffling to achieve power-data decorrelation for power and EM attack counteraction and elimination of residual information leakage from the encryption circuit and/or the neural network.

FIG. 7 shows a schematic diagram of a system architecture 700 for counteracting side channel attacks comprising voltage scaling-agnostic machine learning (VML) based power compensation counteraction and Multiply-Accumulate (MAC) level shuffling in accordance with an embodiment.

The system architecture 700 includes a controller and scheduler 702 configured to provide an address signal to a static random access memory (SRAM) 704. Encrypted parameters of the neural network retrieved from the SRAM 704 at addresses associated with the address signal are then transmitted to an encryption circuit 706. In the present embodiment, the encryption circuit includes an AES circuit and the AES circuit is protected using the VML based power compensation counteraction as described in the method 600 above. The encryption circuit 706 is configured to decrypt the encrypted parameters and the decrypted neural network parameters are provided to processing elements 708. The processing elements 708 comprises processing element tiles and are adapted to receive neural network input data from the SRAM 704 and the decrypted neural network parameters from the encryption circuit 706 to generate outputs associated with the neural network. The processing elements 708 may be comprised in a convolution layer and/or a fully-connected layer of the neural network. In the present embodiment, the processing elements 708 are also protected using the VML based power compensation counteraction as described in the method 600 above. The system architecture 700 further comprises a random sequence generator 710. In the present embodiment, the random sequence generator includes a Fisher-Yates random sequence generator. The random sequence generator 710 is adapted to provide random sequences for use in spatially shuffling an assignment mapping of an output of the neural network to the processing element tiles and shuffling multiplies of the series of MAC operations in a run sequence temporally in the present embodiment. In the present embodiment, the controller and scheduler 702 is also configured to provide a control signal and VML parameters such as dynamic machine learning parameters and static machine learning parameters for controlling the VML based power compensation counteraction in the present embodiment.

A blown-up block diagram 712 of the protected processing element tiles 714 is shown in FIG. 7 to illustrate a working of the VML based power compensation counteraction. As described above, the processing element tiles 714 may be comprised in a convolution layer and/or a fully-connected layer of the neural network. Inputs are received from the processing elements. In the present embodiment, dynamic power parameters and static power parameters are extracted from the inputs using a feature extractor 716. The feature extractor 716 may be configured or controlled by a VML controller 717, which may form part of the controller and scheduler 702. The dynamic power parameters and static power parameters are provided to the ML dynamic power estimator 718 and the ML static power estimator 720, respectively. The ML dynamic power estimator 718 includes a dynamic power compensation ML model and the ML static power estimator 720 includes a static power compensation ML model. The dynamic power compensation ML model and the static power compensation ML model may each include a linear regression machine learning model. As shown in the block diagram 712, the ML dynamic power estimator 718 and the ML static power estimator 720 are decoupled. The dynamic power compensation ML model and the static power compensation ML model are trained using the dynamic power parameters and the static power parameters respectively. Machine learning parameters, including dynamic machine learning parameters for the dynamic power compensation ML model and static machine learning parameters for the static power compensation ML model, may be provided by the VML controller 717 for initializing their respective machine learning models. Trained dynamic power compensation ML model of the ML dynamic power estimator 718 provides dynamic DAC control signal for controlling dynamic power compensation using the dynamic power DACs 722. Similarly, trained static power compensation ML model of the ML static power estimator 720 provides static DAC control signal for controlling static power compensation using the static power DACs 724. In an embodiment, the VML controller provides calibration parameters to the dynamic power DACs 722 and/or the static power DACs 724 for calibrating the respective DACs.

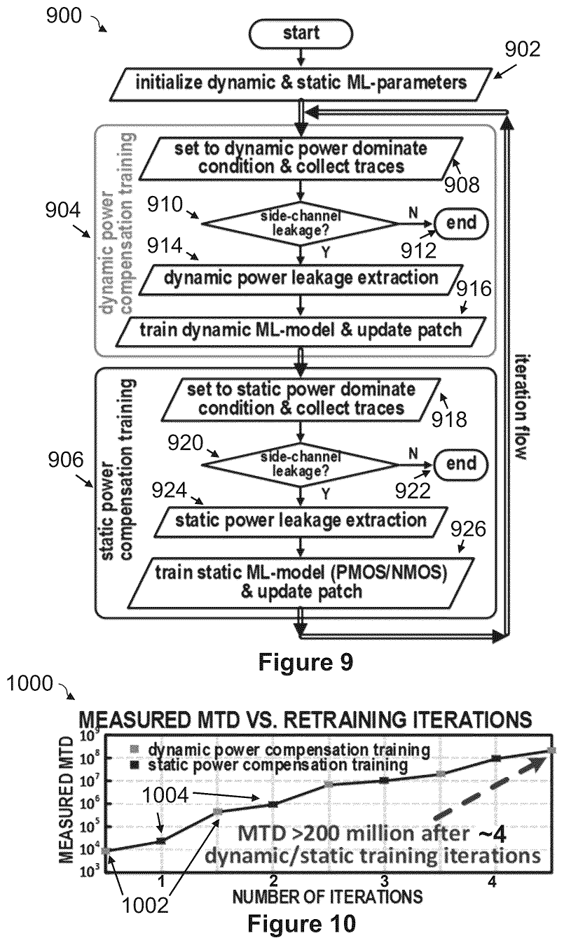

Therefore, as shown in the system architecture 700, voltage scaling-agnostic machine learning (VML) power compensation counteraction can be combined with spatial and temporal shuffling to achieve robust protection against side channel attacks. Particularly, in addition to spatial and/or temporal power-data decorrelation for CPA and EM side channel attack counteraction, higher and more robust protection can be achieved by eliminating residual information leakage from both the encryption circuit and the neural network (e.g. via protection of the processing elements) via the VML power compensation counteraction. Particularly, independent dynamic and static power compensation machine learning models are used to decouple dynamic and static compensations using their respective dynamic and static power DACs, so that protection is effective regardless of the specific voltage (i.e. dynamic/static power ratio). The DACs inherently track the effects of Process-Voltage-Temperature (PVT) variations and voltage scaling in relation to both dynamic power and static power contributions for robust power compensation and attack counteraction. The present counteraction scheme offers a favourable security-overhead trade-off and hardware patching capabilities (see e.g. FIG. 9).

FIG. 8 show circuit diagrams 800 illustrating NOR2-based circuit 802 for PMOS static power compensation and NAND2-based circuit 804 for NMOS static power compensation in accordance with an embodiment. The NOR2-based circuit 802 and the NAND2-based circuit 804 form the basis for 10-bit binarized NAND/NOR-based static power DACs for used in the system architecture 700 as described in relation to FIG. 7. In the present embodiment, the NOR2-gate and the NAND2-gate are the basic units to build a 10-bit static power DAC as shown in relation to FIG. 8. Each of these NOR2-/NAND2-gates are formed by connecting its two inputs together, and as shown in relation to the NOR2-based circuit 802 and the NAND2-based circuit 804, each of the NOR2-/NAND2-gates are followed by a buffer gate. In relation to FIG. 8, cs[i] 806, 808 is the i^{th} control signal received from the power compensation machine learning models, where there are 10-bits in total.

In relation to a NAND2-gate as shown in the NAND2-based circuit 804, a NAND2-gate unit is “ON” when an input is 1 (“ON” means when the NAND2-gate unit can generate a maximum level of static power). However, at the “ON” state where the input is 1, the NAND2-gate unit output is 0. A buffer gate is therefore included to reverse the output from 0 to 1, so that a subsequent NAND2-gate unit in the same chain can also be at an ON state as shown.

Similarly, for a NOR2-gate as shown in the NOR2-based circuit 802, a NOR2-gate unit is “ON” when an input is 0 (“ON” means when the NOR2-gate unit can generate a maximum level of static power). However, at the “ON” state where the input is 0, the NOR2-gate unit output is 1. A buffer gate is therefore included to reverse the output from 1 to 0, so that a subsequent NOR2-gate unit in the same chain can also be at an ON state as shown.

Each bit of NOR2/NAND2-gate chain as shown in relation to the NOR2-based circuit 802 and the NAND2-based circuit 804 is controlled by outputs of the power compensation machine learning models, and this can be referred to as a 2ⁿ (where n is from 0 to 9) static power compensation level in a binary rate. The 10-bit static DAC can therefore be used to build a linear compensation DAC, which can generate the expected static power. The 10-bit binarized NOR2/NAND2-based static power DACs used for static power compensation can be adapted to include high-low leakage with/without stack effect.

Details in relation to dynamic power compensation and dynamic power DACs used can be found in Q. Fang et al., “Side channel attack counteraction via Machine Learning-targeted power compensation for post-silicon HW security patching,” IEEE International Solid-State Circuits Conference (ISSCC), February 2022, and the entirety of this reference is incorporated herein. In the present embodiment, 10-bit inverter-based dynamic DACs and NAND/NOR-based static power DACs are driven by on-chip linear regression dynamic power compensation ML model and static power compensation ML model as exemplified in relation to FIG. 7.

FIG. 9 shows a flowchart of a method 900 for training a dynamic power compensation ML model and a static power compensation ML model in accordance with an embodiment. The method 900 alternatively and iteratively trains both the dynamic power compensation ML model and the static power compensation ML model, incorporating all dynamic and static power contributions from power DACs, NN and AES for true system-level VML power compensation counteraction.

To begin, in a step 902, the ML power compensation unit 528 is executed by the processor 502 to initialise dynamic machine learning parameters for the dynamic power compensation ML model and static machine learning parameters for the static power compensation ML model. Once the dynamic machine learning parameters and the static machine learning parameters are initialised, the dynamic power compensation ML model and the static power compensation ML model are trained independently as shown by a dynamic power compensation training block 904 and a static power compensation training block 906.

The dynamic power compensation training block 904 includes steps 908, 910, 912, 914 and 916.

In a step 908, the ML power compensation unit 528 is executed by the processor 502 to set the system to dynamic power dominate condition and receive the dynamic power traces associated with the initialised dynamic machine learning parameters from the processing element tiles.

The system receives a side channel attack (or a simulated side channel attack) and in a step 910, the ML power compensation unit 528 is executed by the processor 502 to determine if there is a side channel leakage as a result of the side channel attack to the system.

If it is determined that there is no side channel leakage, the ML power compensation unit 528 is executed by the processor 502 to end the training of the dynamic power compensation ML model and the static power compensation ML model, i.e. the method 900.

If it is determined that there is a side channel leakage, the ML power compensation unit 528 is executed by the processor 502 to extract dynamic power leakage parameters using the dynamic power compensation ML model in a step 914 and to train the dynamic power compensation ML model based on the extracted dynamic power leakage parameters in a step 916. In an embodiment, the ML power compensation unit 528 is executed by the processor 502 in the step 916 to update or to notify the user of the system to update a hardware patch and/or a software patch to the system.

Upon completion of the dynamic power compensation training block 904, the method proceeds to the static power compensation training block 906 which includes steps 918, 920, 922, 924 and 926.

In a step 918, the ML power compensation unit 528 is executed by the processor 502 to set the system to static power dominate condition and to receive the static power traces associated with the initialised static machine learning parameters from the processing element tiles.

The system receives a further or another side channel attack (can be simulated) and in a step 920, the ML power compensation unit 528 is executed by the processor 502 to determine if there is a further side channel leakage as a result of the further side channel attack to the system.

If it is determined that there is no further side channel leakage, the ML power compensation unit 528 is executed by the processor 502 to end the training of the dynamic power compensation ML model and the static power compensation ML model, i.e. the method 900.

If it is determined that there is a further side channel leakage, the ML power compensation unit 528 is executed by the processor 502 to extract static power leakage parameters using the static power compensation ML model in a step 924 and to train the static power compensation ML model based on the static power leakage parameters in a step 926. Similar to the step 916, in an embodiment, the ML power compensation unit 528 is executed by the processor 502 in the step 926 to update or to notify the user of the system to update a hardware patch and/or a software patch to the system.

As shown in FIG. 9, the dynamic power compensation training block 904 and the static power compensation training block 906 can be repeated until a predetermined minimum trace to disclosure (MTD) is achieved. By training the power compensation machine learning models as described above iteratively, any changes in an external condition (e.g. temperature or changes in relation to parameters of a to-be-protected neural network model) can be adapted or “patched” (e.g. hardware and/or software patching) due to re-programmability of the power compensation machine learning models by e.g. conducting another round of “iterative training”.

FIG. 10 shows a graph 1000 of measured minimum traces to disclosure (MTD) versus a number of retraining iterations for training the dynamic power compensation ML model and the static power compensation ML model using the method of FIG. 9 in accordance with an embodiment. The data points 1002 represent the dynamic power compensation ML model training iteration and the data points 1004 represent the static power compensation ML model training iteration.

As shown in the graph 1000, the measured MTD increases to more than 200 million traces after about 4 training iterations of the dynamic/static power compensation ML model training.

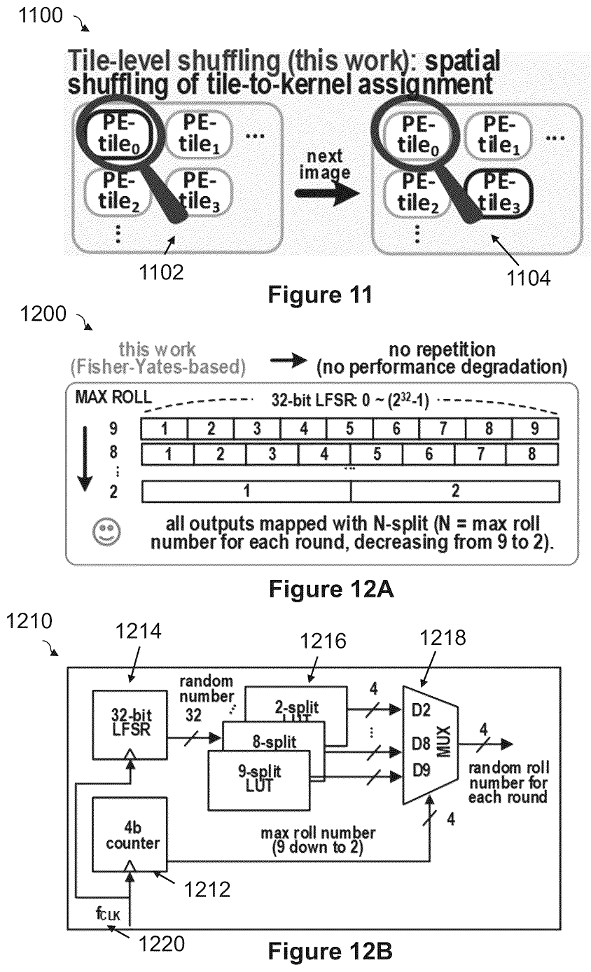

FIG. 11 shows a schematic diagram 1100 illustrating spatial shuffling of an assignment mapping of an output of the neural network (e.g. convolutions of the neural network) to processing element tiles of the system for counteracting side channel attacks in accordance with an embodiment. An output of the neural network as described here is to be understood to include an output within the neural network, for example, an output of a layer (e.g. a convolutional layer etc.) within the neural network.

As shown in relation to FIG. 11, an attacker can use an EM probe (represented by a magnifying glass here) to perform an EM attack on a chip. Typically, a position of the EM probe is fixed to a position close to a data-processing PE tile in order to get higher SNR EM traces. By employing PE tile-level spatial shuffling, data is being processed at different PE tiles at different locations (e.g. from PE tile₀ to PE tile₃ in this case) so that the EM probe is prevented from recording a EM trace correctly, or even if a EM trace can be recorded, at a much lower SNR. The PE tile-level spatial shuffling therefore randomises allocated PE tiles for processing neural network (NN) layer data or NN layer computation so that the processed data are arranged randomly at different PE tiles at different locations on the chip.

FIG. 12A and FIG. 12B are diagrams illustrating a Fisher-Yates random sequence generator (RSG) for use in MAC level shuffling for counteracting side channel attacks in accordance with an embodiment.

FIG. 12A is a diagram 1200 illustrating an efficiency of spatial shuffling where all outputs are mapped with N-splits with zero latency overhead. In the present embodiment, a Fisher-Yates random sequence generator (RSG) is used which effectively eliminates or reduces a latency overhead as compared to a conventional MAC-level run-time shuffling using, for example, a linear-feedback shift register (LSFR)-based random sequence generator (see e.g. FIG. 4B). As shown in FIG. 12A, all outputs using the Fisher-Yates RSG are mapped with N-split (where N=a maximum roll number for each round, decreasing from 9 to 2). and achieves a full coverage with no value repetition (i.e. no latency overhead).

In the present embodiment, the Fisher-Yates random sequence generator (RSG) as shown in FIG. 12A provides a more efficient way to generate a random value from 2 to 9. Based on the Fisher-Yates shuffling, random values from 1 to 9 are generated in round 1 (i.e. N=9), random values from 1 to 8 are generated in round 2 (i.e. N=8) and so forth, until round 8 (i.e. N=2) where random values of 1 and 2 are generated. In the present embodiment, a 32-bit LFSR is used to generate a random value within a very huge range (0 to 232-1), and the generated random value is then used to compare with stored comparison tables (i.e. look-up tables (LUTs)) to determine a random output for each round of the Fisher-Yates shuffling scheme. Using round 8 as an example, the random value generated by the 32-bit LFSR is compared to a comparison table where if the random value generated by the 32-bit LFSR is more than 232/2, then the output is 2, otherwise, the output of round 8 is 1. Different comparison tables can therefore be constructed and stored in memory for each round in a similar manner (e.g. in relation to round 7 of the present embodiment, where the random values is selected from 1 to 3, a look-up tables may have a random value of 1 for a 32-but LFSR generated value ranging from 0 to <232/3; a random value of 2 for a 32-but LFSR generated value ranging between 232/3 and (2×232/3); and a random value of 3 for a 32-but LFSR generated value ranging between 232/3 and less than 232). In this way, the Fisher-Yates random sequence generator of FIG. 12A can be adapted to generate different random numbers from 2 to 9 with no latency loss.

FIG. 12B is a diagram illustrating an architecture 1210 of the Fisher-Yates random sequence generator (RSG) in accordance with an embodiment.

As shown in FIG. 12B, the Fisher-Yates-based random sequence generator (RSG) includes a 4-bit counter 1212, a 32-bit LFSR 1214, N-splits (in the present case, N=2 to 9) of look-up tables (LUT) 1216 and a multiplexer (MUX) 1218. The multiplexer (MUX) 1218 is adapted to randomly select one of the N-splits to be output based on the 4-bit counter 1212. A clock function (f_{CLK}) 1220 provides input signals to the 4-bit counter 1212 and the 32-bit LFSR (1214).

Therefore, based on the discussions above in relation to FIGS. 12A and 12B, Fisher-Yates based random sequence generator (RSG) can be adapted to generate random sequence of [1 to N] values in (N−1) cycles with no cycle waste (zero latency overhead).

The Fisher-Yates RSG as described can therefore be used in place of a LSFR random sequence generator for shuffling multiplies of a series of MAC operations in a run sequence temporally with an eliminated latency overhead typical of conventional MAC-level run-time shuffling by having all outputs mapped with the N-split (where N=a maximum roll number for each round, decreasing from 9 to 2), thereby achieving a full coverage of the outputs with no value repetition (i.e. no latency overhead). It should also be appreciated that the Fisher-Yates RSG can be applied to spatially shuffle the assignment mapping of the output of the neural network to the processing element tiles as described in FIG. 11 above. Therefore, one or more Fisher-Yates RSGs can be applied, in an embodiment, to both temporally shuffling multiplies of a series of MAC operations and spatially shuffling the assignment mapping of an output of the neural network to the processing element tiles in an embodiment. For example, if both temporal shuffling and spatial shuffling are configured to generate a same random sequence range (e.g. both these shufflings are configured to generate a value from 1 to 9), then a same Fisher-Yates RSG as shown in relation to FIG. 12B can be used. In another embodiment, if the temporal shuffling and the spatial shuffling are using different ranges of a random sequence (e.g. one uses a random value from 1 to 9 while the other uses a random value from 1 to 10), a similar circuit architecture as shown in FIG. 12B can be used, but with different N-split LUT outputs being required. In some embodiments, different configurations of the N-split LUT outputs employed in a Fisher-Yates RSG may be considered as different Fisher-Yates random sequence generators.

Using the aforementioned described spatial shuffling to randomise mapping of outputs of the neural network (e.g. convolutions of the neural network) to processing element (PE) tiles in an array, in addition to, MAC-level temporal shuffling of multiplies of a series of MAC operations in a run sequence, a spatial and temporal power-data correlation can be broken, thereby counteracting EM side channel attacks while eliminating the need for extra usage of routing resources for high metal layer shielding and low metal power routing. Further, the tile-level randomisation offers by the spatial shuffling method also degrades signal-to-noise ratio (SNR) of an EM attack.

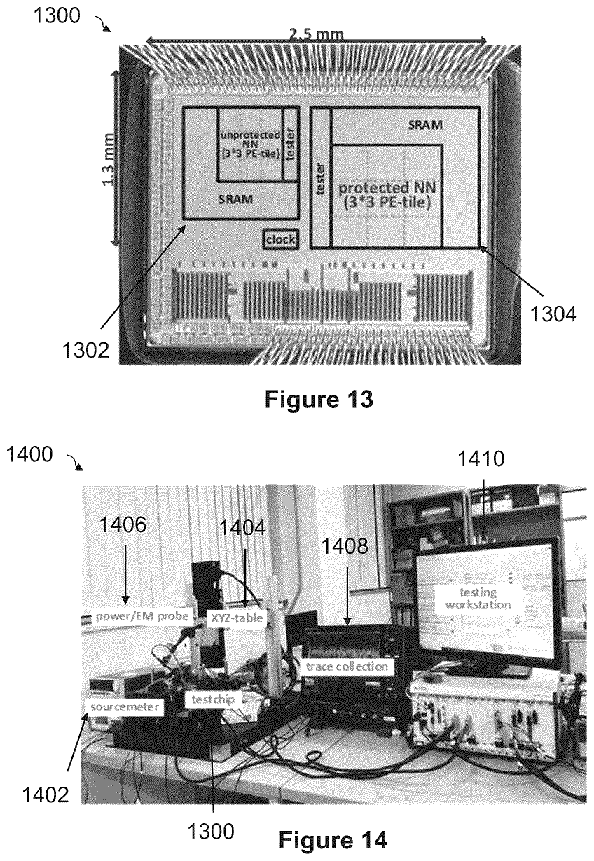

FIG. 13 shows a micrograph of a 40-nm technology node test chip 1300 for use in simulated CPA and EM side channel attacks in accordance with an embodiment. As shown in FIG. 13, the test chip 1300 includes an unprotected neural network 1302 having a 3×3 processing element array and a protected neural network 1304 having a 3×3 processing element array.

FIG. 14 shows a photograph of an experimental setup 1400 for simulating side channel attacks on the test chip 1300 of FIG. 13 in accordance with an embodiment.

As shown in FIG. 14, the experimental setup 1400 includes a source meter 1402 adapted to supply current/voltage to the test chip 1300. The test chip 1300 is placed on a XYZ-table 1404 which allows movement of the test chip 1300 in the three Cartesian orthogonal axes (i.e. X-axis, Y-axis and Z-axis). A power/EM probe 1406 is provided above the test chip 1300 and is adapted to simulate the CPA and/or EM side channel attacks on the test chip 1300. A trace collector 1408 is connected to the test chip 1300 for collecting power traces from the test chip 1300 and the data collected from the test chip 1300 is fed to a testing workstation 1410 for analysing the data and determining a minimum trace to disclosure (MTD) for the experiments.

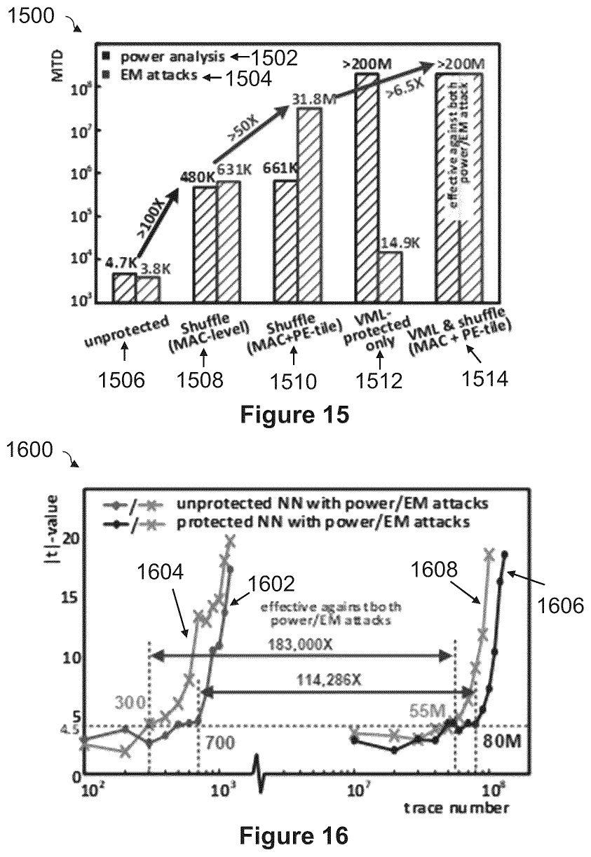

FIG. 15 shows a graph 1500 of MTDs for unprotected and protected neural networks (NNs) under correlation power attacks (CPA) and electromagnetic attacks in accordance with an embodiment. A pair of bar charts of MTDs measured in relation to the CPA attack 1502 and the EM attack 1504 is shown for each of five configurations used in the present experiment. In the present experiment, the five configurations include (i) an unprotected NN 1506, (ii) protected NN with MAC-level or temporal shuffling counteraction 1508, (iii) protected NN with a combination of MAC-level (or temporal shuffling) and spatial shuffling counteraction 1510, (iv) protected NN with system-level voltage scaling-agnostic machine learning (VML) power compensation counteraction 1512, and (v) protected NN with system-level voltage scaling-agnostic machine learning (VML) power compensation counteraction and a combination of MAC-level and spatial shuffling counteraction 1514.

As shown in the graph 1500, the minimum traces to disclosure (MTD) of the unprotected neural network are improved for more than 100 times in relation to both the CPA and EM attacks by using the Fisher-Yates MAC-level shuffling (temporal power-data decorrelation) as described in relation to FIGS. 12A and 12B. Introducing the spatial shuffling of the PE tiles further improves the MTD for EM attacks by more than 50 times, although there is much less improvement in relation to CPA attacks. Adding the VML power compensation in combination with the dual shuffling combination (see 1514), the MTDs are further improved by more than five times where the MTDs for the CPA and the EM attacks are each more than 200 Million MTDs. It is noted that in the present experiment, MTDs were not tested beyond 200 million and so the encrypted information/key may remain undisclosed at higher MTDs (i.e. beyond 200 million). For the configuration (iv) where only the VML power compensation counteraction was used, the MTD in relation to a CPA attack is more than 200 million but the MTD for an EM attack is about 14.9 thousand. It shows that the VML power compensation counteraction alone is less effective under EM attacks.

FIG. 16 shows a graph 1600 of test vector leakage assessment (TVLA) tests for unprotected and protected neural networks in accordance with an embodiment. The graph shows |t| value versus trace number for an unprotected NN using CPA attack 1602 and EM attack 1604 and a protected NN using CPA attack 1606 and EM attack 1608. The protected NN uses the VML power compensation counteraction and a combination of MAC-level and spatial shuffling counteraction in the present TVLA tests.

Referring back to FIG. 15, the protected NN 1514 achieves state-of-the-art MTD of >200 million after about 4 training iterations, showing improved MTDs by about 42,600× and about 52,600× for CPA attacks and EM attacks, respectively, over the unprotected neural network 1506. This is consistent with the TVLA test results as shown in the graph 1600 which shows an improvement of about 114,000× and 183,000× for CPA attacks and EM attacks, respectively, for the protected NN over the unprotected NN. Notably, the improvement as shown in the present experiments is around 100× better than the prior best MTD achieved using TI-based method, with a reduction of a power overhead from 5.48× to 1.76×, thanks to the synergistic nature of the proposed combination of the VML power-compensation counteraction and the dual temporal and spatial shuffling counteraction method.

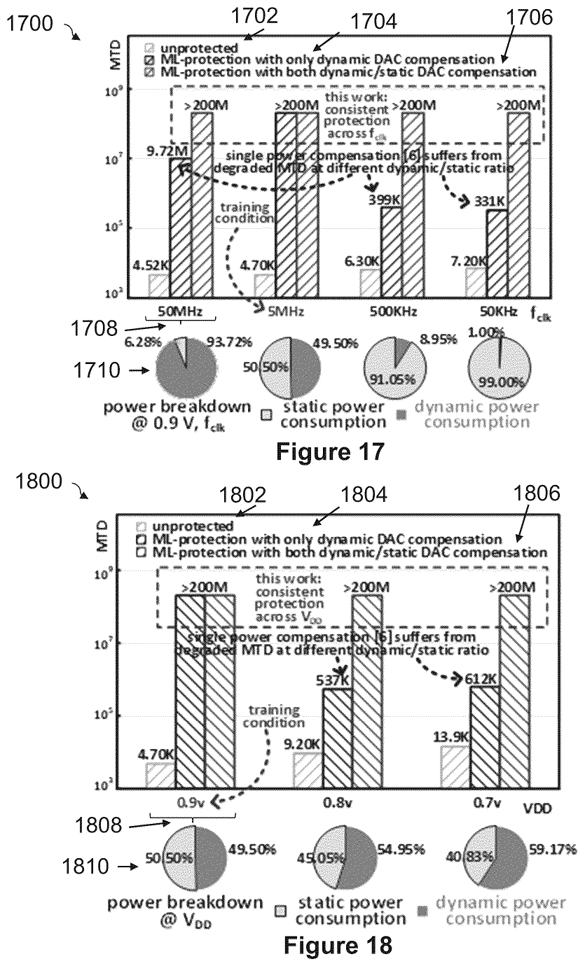

FIG. 17 shows charts 1700 illustrating frequency scaling and its impact on MTDs for unprotected and protected neural networks, and dynamic power-to-static power ratio of the neural network, in accordance with an embodiment. As shown in FIG. 17, data in relation to the unprotected neural network 1702 is at a left, data in relation to a protected neural network with only dynamic DAC power compensation 1704 is in a middle, and data in relation to a protected neural network with both dynamic and static DAC power compensation 1706 is at a right of each triplet of bar chart data shown for each clock frequency f_{CLK} of 50 MHZ, 5 MHZ, 500 KHz and 50 KHz. An example of a triplet of bar chart data 1708 is shown for a folk of 50 MHz.

As shown in FIG. 17, the protected NN having only the dynamic DAC power compensation 1704 has a MTD of more than 200 million only at a folk of 5 MHZ, but suffered from degraded MTDs at other clock frequencies f_{CLK}. In contrast, the protected neural network with both dynamic and static DAC power compensation 1706 consistently has a MTD of more than 200 million across all the four f_{CLK} of 50 MHZ, 5 MHZ, 500 KHz and 50 KHz. Also shown in FIG. 17 are the pie charts 1710 which show a dynamic power to static power ratio for the four folk of 50 MHZ, 5 MHZ, 500 KHz and 50 KHz. As is evidence from these pie charts 1710, the dynamic power to static power ratio changes with varying f_{CLK}. It can therefore be concluded that while the protected NN having only the dynamic DAC power compensation 1704 has an effective protection only at a specific dynamic power to static power ratio, the protected NN having both the dynamic and static DAC power compensation 1706 has an effective protection across different dynamic power to static power ratios.

FIG. 18 shows charts illustrating supply voltage scaling and its impact on MTDs for unprotected and protected neural networks, and dynamic power-to-static power ratio of the neural network, in accordance with an embodiment. As shown in FIG. 18, data in relation to the unprotected neural network 1802 is at a left, data in relation to a protected neural network with only dynamic DAC power compensation 1804 is in a middle, and data in relation to a protected neural network with both dynamic and static DAC power compensation 1806 is at a right of each triplet of bar chart data shown for each supply voltage VDD of 0.9 V, 0.8 V and 0.7 V. An example of a triplet of bar chart data 1808 is shown for a VDD of 0.9 V.

As shown in FIG. 18, the protected NN having only the dynamic DAC power compensation 1804 has a MTD of more than 200 million only at a VDD of 0.9 V, but suffered from degraded MTDs at other supply voltages. In contrast, the protected neural network with both dynamic and static DAC power compensation 1806 consistently has a MTD of more than 200 million across all the three VDDs of 0.9 V, 0.8 V and 0.7 V. Also shown in FIG. 18 are the pie charts 1810 which show a dynamic power to static power ratio for the three supply voltages V_{DD} of 0.9 V, 0.8 V and 0.7 V. As is evidence from these pie charts 1810, the dynamic power to static power ratio changes with varying VDD. Similarly, it can therefore be concluded that while the protected NN having only the dynamic DAC power compensation 1804 has an effective protection only at a specific dynamic power to static power ratio, the protected NN having both the dynamic and static DAC power compensation 1806 has an effective protection across different dynamic power to static power ratios.

In conclusion, a prototype of a system of the present disclosure has been manufactured using on-chip neural network PE-arrays and its protection performance has been investigated and supported by the silicon measurement results shown in relation to FIGS. 15 to 18. The Minimum Trace to Disclose (MTD) for the protected NN using a combination of VML based power compensation counteraction and dual temporal and spatial shuffling counteraction exceeds 200 million against CPA and EM attacks, which show improvements of over 42,600× and 52,600× as compared with unprotected cores, respectively. Same level of protection was achieved under voltage scaling with MTD remaining at more than 200 million at different dynamic power to static power ratios. This state-of-the-art protection (>200 million MTD) is achieved with a low power overhead (1.76×) and zero latency overhead. Compared with existing TI based counteraction method, the method and system of the present disclosure provides 100× improvement on MTD with 3.1× lower power overhead and zero latency overhead. Further, the proposed voltage scaling-agnostic machine learning (VML) based power compensation counteraction against neural network weight reverse engineering is robust with respect to voltage scaling with different dynamic/static power ratios, and can be extended to different neural networks and/or digital circuits which require protection against side channel attacks. The proposed Fisher-Yates based random sequence generator can be applied to different scenarios where random sequence needs to be generated with zero latency.

### Comments

It should be appreciated that previous works used only temporal shuffling and no spatial shuffling. In an embodiment where the two shufflings (i.e. temporal shuffling and spatial shuffling) are used in combination, improvements are shown in relation to not only correlation power analysis attack but also EM attacks protection.

The random sequence generator based on Fisher-Yates shuffling was adopted in the present embodiment, rather than the previously used linear feedback shift register (LFSR) based one, achieving zero latency degradation. The Fisher-Yates based random sequence generator can be applied to the temporal shuffling and/or the spatial shuffling as described above. In other embodiments, the temporal shuffling and/or the spatial shuffling described are not limited to using the Fisher-Yates based random sequence generator as discussed, and a LFSR based random sequence generator can be applied to the temporal shuffling and/or the spatial shuffling.

It should be appreciated that the present disclosure is the first demonstration of implementing the Fisher-Yates random sequence generator on chip (with ASIC).

It should be appreciated that the trained dynamic and static power machine learning (ML) models/DACs of the present embodiments are tracking the dynamic/static power ratio of the overall system, so that the proposed counteraction is “voltage scaling agnostic”-which means that no matter the ratio of dynamic/static power in the system due to the change of voltage scaling, the proposed dual ML based compensation will be accurate and the protection will be robust.

It should be appreciated that the AES is an example of an encryption circuit which is used to protect the weight values used in a neural network accelerator from unauthorized disclosure. The other methods protect the weight values used in the neural network accelerator from side channel attacks to disclose their secret value. The weight values are protected to keep the neural network secret to the user.

It should be appreciated that although the VML-based dynamic and static power compensation counteraction and the dual temporal and spatial shuffling counteraction are used in combination in the embodiment of the present disclosure, these counteraction methods can be used independently. For example, the VML-based dynamic and static power compensation counteraction can be used independently. The dual temporal and spatial shuffling counteraction can be used independently. Further, a temporal shuffling counteraction based on a Fisher-Yates random sequence generator or the spatial shuffling of an assignment mapping of an output (e.g. convolutions) of the neural network to the processing element tiles may also be used independently as counteraction against side channel attacks.

The system in the present embodiment may include an on-chip neural network. The neural network may comprise processing elements. In the present embodiment, one dynamic power compensation ML model and one static power compensation ML model are sufficient to protect the overall system including all components. The dynamic power compensation ML model and the static power compensation ML model may be adapted to protect not only the encryption circuit (such as an AES) but also the neural network parameters (such as weights) processed in the PE array. This can be achieved, for example, by extracting side-channel leakages from the overall system (i.e. inclusive of all protected components) during the training process for training the dynamic power compensation ML model and the static power compensation ML model for targeting compensation of the overall system. The training process of the dynamic power compensation ML model and the static power compensation ML model can be offline.

Although only certain embodiments of the present invention have been described in detail, many variations are possible in accordance with the appended claims. For example, features described in relation to one embodiment may be incorporated into one or more other embodiments and vice versa.

1. A method for counteracting side channel attacks in a system comprising a neural network including processing element tiles, the method comprising:
spatial shuffling, using a first random sequence generator, an assignment mapping of an output of the neural network to the processing element tiles, wherein the output of the neural network includes a series of Multiply-Accumulate (MAC) operations; and
temporal shuffling, using a second random sequence generator, multiplies of the series of MAC operations in a run sequence temporally.

2. The method of claim 1, wherein a same random sequence generator is adapted to be used as the first random sequence generator and the second random sequence generator.

3. The method of claim 1, wherein the first random sequence generator or the second random sequence generator includes a Fisher-Yates random sequence generator.

4. The method of claim 1, wherein the system further comprises a machine learning (ML) power compensation unit, dynamic power digital-to-analogue converters (DACs) and static power digital-to-analogue converters (DACs), the method further comprising:
receiving, from the processing element tiles, inputs in relation to dynamic power parameters and static power parameters;
training a dynamic power compensation ML model associated with the ML power compensation unit, using the dynamic power parameters, to form a trained dynamic power compensation ML model;
training a static power compensation ML model associated with the ML power compensation unit, using the static power parameters, to form a trained static power compensation ML model;
controlling, using the trained dynamic power compensation ML model, dynamic power compensation using the dynamic power DACs; and
controlling, using the trained static power compensation ML model, static power compensation using the static power DACs,
wherein the steps of training the dynamic power compensation ML model and training the static power compensation ML model are performed offline.

5. The method of claim 4, further comprising:
receiving dynamic power inputs and static power inputs associated with the neural network and/or an encryption circuit of the system;
training the trained dynamic power compensation ML model, using the dynamic power inputs, to form a further trained dynamic power compensation ML model;
training the trained static power compensation ML model, using the static power inputs, to form a further trained static power compensation ML model;
controlling, using the further trained dynamic power compensation ML model, dynamic power compensation associated with the neural network and/or the encryption circuit of the system; and
controlling, using the further trained static power compensation ML model, static power compensation associated with the neural networks and/or the encryption circuit of the system.

6. The method of claim 5, wherein the encryption circuit includes an Advanced Encryption Standard circuit, the encryption circuit is adapted to protect a dynamic power-to-static power ratio used in the neural network from unauthorized disclosure.

7. The method of claim 4, wherein the dynamic power parameters include dynamic power traces and the static power parameters include static power traces, training the dynamic power compensation ML model using the dynamic power parameters and training the static power compensation ML model using the static power parameters comprises:
(i) initialising dynamic machine learning parameters for the dynamic power compensation ML model and static machine learning parameters for the static power compensation ML model;
(ii) setting the system to dynamic power dominate condition and receiving the dynamic power traces associated with the initialised dynamic machine learning parameters from the processing element tiles;
(iii) determining if there is a side channel leakage as a result of a side channel attack to the system;
(iv) if it is determined that there is no side channel leakage, ending the training of the dynamic power compensation ML model and the static power compensation ML model; or
(v) if it is determined that there is a side channel leakage, extracting dynamic power leakage parameters using the dynamic power compensation ML model and training the dynamic power compensation ML model based on the extracted dynamic power leakage parameters;
(vi) setting the system to static power dominate condition and receiving the static power traces associated with the initialised static machine learning parameters;
(vii) determining if there is a further side channel leakage as a result of a further side channel attack to the system;
(viii) if it is determined that there is no further side channel leakage, ending the training of the dynamic power compensation ML model and the static power compensation ML model; or
(ix) if it is determined that there is a further side channel leakage, extracting static power leakage parameters using the static power compensation ML model and training the static power compensation ML model based on the static power leakage parameters, wherein the steps (ii) to (ix) above are repeated until a predetermined minimum trace to disclosure (MTD) is achieved.

8. The method of claim 4, wherein the dynamic power DACs include a 10-bit inverter-based dynamic power DACs and the static power DACs include NAND-based or NOR-based static power DACs.

9. A method for counteracting side channel attack in a system comprising a neural network including processing element tiles, a machine learning (ML) power compensation unit, dynamic power digital-to-analogue converters (DACs) and static power digital-to-analogue converters (DACs), the method comprising:
receiving, from the processing element tiles, inputs in relation to dynamic power parameters and static power parameters;
training, a dynamic power compensation ML model associated with the ML power compensation unit, using the dynamic power parameters to form a trained dynamic power compensation ML model;
training, a static power compensation ML model associated with the ML power compensation unit, using the static power parameters to form a trained static power compensation ML model;
controlling, using the trained dynamic power compensation ML model, dynamic power compensation using the dynamic power DACs; and
controlling, using the trained static power compensation ML model, static power compensation using the static power DACs,
wherein the steps of training the dynamic power compensation ML model and training the static power compensation ML model are performed iteratively,
wherein the steps of training the dynamic power compensation ML model and training the static power compensation ML model are performed offline.

10. The method of claim 9, wherein the dynamic power parameters include dynamic power traces and the static power parameters include static power traces, training the dynamic power compensation ML model using the dynamic power parameters and training the static power compensation ML model using the static power parameters comprises:
(i) initialising dynamic machine learning parameters for the dynamic power compensation ML model and static machine learning parameters for the static power compensation ML model;
(ii) setting the system to dynamic power dominate condition and receiving the dynamic power traces associated with the initialised dynamic machine learning parameters from the processing element tiles;
(iii) determining if there is a side channel leakage as a result of a side channel attack to the system;
(iv) if it is determined that there is no side channel leakage, ending the training of the dynamic power compensation ML model and the static power compensation ML model; or
(v) if it is determined that there is a side channel leakage, extracting dynamic power leakage parameters using the dynamic power compensation ML model and training the dynamic power compensation ML model based on the extracted dynamic power leakage parameters;
(vi) setting the system to static power dominate condition and receiving the static power traces associated with the initialised static machine learning parameters from the processing element tiles;
(vii) determining if there is a further side channel leakage as a result of a further side channel attack to the system;
(viii) if it is determined that there is no further side channel leakage, ending the training of the dynamic power compensation ML model and the static power compensation ML model; or
(ix) if it is determined that there is a further side channel leakage, extracting static power leakage parameters using the static power compensation ML model and training the static power compensation ML model based on the static power leakage parameters,
wherein the steps (ii) to (ix) above are repeated until a predetermined minimum trace to disclosure (MTD) is achieved.

11. A system for counteracting side channel attacks, the system comprising:
a neural network including processing element tiles, the neural network being adapted to generate an output as a series of Multiply-Accumulate (MAC) operations;
a first random sequence generator adapted to be used in spatial shuffling an assignment mapping of the output of the neural network to the processing element tiles; and
a second random sequence generator configured to be used in temporal shuffling multiplies of the series of MAC operations in a run sequence temporally.

12. The system of claim 11, wherein a same random sequence generator is adapted to be used as the first random sequence generator and the second random sequence generator.

13. The system of claim 11, wherein the first random sequence generator or the second random sequence generator includes a Fisher-Yates random sequence generator.

14. The system of claim 11, further comprising:
a machine learning (ML) power compensation unit adapted to track a dynamic power-to-static power ratio of the system, the ML power compensation unit comprising a dynamic power compensation ML model and a static power compensation ML model;
dynamic power digital-to-analogue converters (DACs); and
static power digital-to-analogue converters (DACs),
wherein inputs in relation to dynamic power parameters and static power parameters received from the processing element tiles are used to train the dynamic power compensation ML model to form a trained dynamic power compensation ML model and to train a static power compensation ML model to form a trained static power compensation ML model, respectively,
wherein the ML power compensation unit is further adapted to control dynamic power compensation associated with the dynamic power DACs using the trained dynamic power compensation ML model and to control static power compensation associated with the static power DACs using the trained static power compensation ML model, and
wherein training of the dynamic power compensation ML model and training the static power compensation ML model are performed offline.

15. The system of claim 14, wherein dynamic power inputs and static power inputs associated with the neural network and/or an encryption circuit of the system are used to train the trained dynamic power compensation ML model and the trained static power compensation ML model respectively to form a further trained dynamic power compensation ML model and a further trained static power compensation ML model, the ML power compensation unit is further adapted to:
control, using the further trained dynamic power compensation ML model, dynamic power compensation associated with the neural network and/or the encryption circuit of the system; and
control, using the further trained static power compensation ML model, static power compensation associated with the neural networks and/or the encryption circuit of the system.

16. The system of claim 15, wherein the encryption circuit includes an Advanced Encryption Standard circuit, the encryption circuit is adapted to protect a dynamic power-to-static power ratio used in the neural network from unauthorized disclosure.

17. The system of claim 14, wherein the dynamic power parameters include dynamic power traces and the static power parameters include static power traces, the ML power compensation unit is further adapted to:
(i) initialise dynamic machine learning parameters for the dynamic power compensation ML model and static machine learning parameters for the static power compensation ML model;
(ii) set the system to dynamic power dominate condition and receive the dynamic power traces associated with the initialised dynamic machine learning parameters from the processing element tiles;
(iii) determine if there is a side channel leakage as a result of a side channel attack to the system;
(iv) if it is determined that there is no side channel leakage, end the training of the dynamic power compensation ML model and the static power compensation ML model; or
(v) if it is determined that there is a side channel leakage, extract dynamic power leakage parameters using the dynamic power compensation ML model and train the dynamic power compensation ML model based on the extracted dynamic power leakage parameters;
(vi) set the system to static power dominate condition and receive the static power traces associated with the initialised static machine learning parameters from the processing element tiles;
(vii) determine if there is a further side channel leakage as a result of a further side channel attack to the system;
(viii) if it is determined that there is no further side channel leakage, end the training of the dynamic power compensation ML model and the static power compensation ML model; or
(ix) if it is determined that there is a further side channel leakage, extract static power leakage parameters using the static power compensation ML model and train the static power compensation ML model based on the static power leakage parameters,
wherein the ML power compensation unit is further adapted to repeat the steps (ii) to (ix) above until a predetermined minimum trace to disclosure (MTD) is achieved.

18. The system of claim 14, wherein the dynamic power DACs include a 10-bit inverter-based dynamic power DACs and the static power DACs include NAND-based or NOR-based static power DACs.

19-20. (canceled)
